(19) United States
(12) Patent Application Publication
(10) Pub. No.: US 2018/0341716 A1
(43) Pub. Date: Nov. 29, 2018

(54) SUGGESTED CONTENT GENERATION

(71) Applicant: Microsoft Technology Licensing, LLC, Redmond, WA (US)

(72) Inventor: Rukmini IYER, Los Altos, CA (US)

(73) Assignee: Microsoft Technology Licensing, LLC, Redmond, WA (US)

(21) Appl. No.: 15/607,128

(22) Filed: May 26, 2017

(51) Int. Cl. G06F 17/30; G06Q 30/02; H04L 29/08

(52) U.S. Cl. CPC G06F 17/30902; G06Q 30/0202; G06Q 50/01; G06Q 30/0201; H04L 67/22; G06F 17/30035

(57) ABSTRACT

Examples of the present disclosure describe systems and methods for suggested content generation. In an example, a publisher may provide content to a user during a browsing session of the user. A domain associated with the browsing session may be identified, such that suggested content relating to the browsing session may be provided for display in addition to the provided content. The suggested content may omit content provided by the publisher, so as to avoid providing redundant content or reducing user interest in the content provided by the publisher. As a result, the user may interact with the suggested content when progressing through a browsing session rather than navigating away from the publisher. This may enable the publisher to gain insight into the browsing session of the user while also improving the browsing session of the user by making relevant content more easily accessible to the user.

### BACKGROUND

A user may browse for content during a browsing session consisting of multiple browsing session topics. When the user finishes perusing content from a publisher relating to a first browsing session topic, the user may progress to the next browsing session topic. If the publisher does not provide content relating to the second browsing session topic, the user may instead access content from a different publisher, thereby causing the initial publisher to potentially lose insight into the user's browsing session.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for suggested content generation to maintain user session continuity. In an example, a publisher may provide content to a user during a browsing session of the user. A domain associated with the browsing session may be identified, such that suggested content relating to the domain of the browsing session may be provided for display in addition to the provided content. As a result, the user may interact with the suggested content when progressing through a browsing session, rather than navigating to another publisher or searching via a search provider. This may enable the publisher to gain insight into the browsing session of the user while also improving the browsing session of the user by making relevant content more easily accessible during the browsing session.

Suggested content may be generated using one or more of a variety of techniques, including, but not limited to, using an n-gram model for a sequence of browsing session topics to identify a next probable browsing session topic, based on information provided by a publisher, or based on search index information comprising websites listing related or similar content. As used herein, the term “session topic” may refer to any subject-matter boundary within a single browsing session. The suggested content may omit content provided by the current publisher, so as to avoid providing redundant content or reducing user interest in the content provided by the publisher.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for suggested content generation.

FIG. 2A illustrates an overview of an example method for suggested content generation.

FIG. 2B illustrates an overview of an example method for generating a model to perform suggested content generation.

FIG. 3 illustrates an overview of an example method for requesting and displaying suggested content.

FIGS. 4A-4C illustrate overviews of example user interfaces for displaying suggested content.

FIG. 5 is a block diagram illustrating example physical components of a computing device with which aspects of the disclosure may be practiced.

FIG. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, content from a publisher may be presented using a website, wherein one or more webpages of the website may be accessed by a user via a client device. Content from the website may be accessed by the user as a result of navigating to the website or accessing the website via a search provider, among other examples. The user may access the content as part of a browsing session, during which the user may access content from one or more publishers. As an example, a user may be searching for a series of products using a search engine, and may access a product listing webpage on a website of a retailer. The user may purchase the product from the retailer, and may then return to the search engine to search for the next product in the series of products during the user's browsing session. As a result of the user navigating away from the website when continuing the browsing session, the retailer may lose the opportunity to gather information relating to the user's browsing session (e.g., other products the retailer should stock, businesses with which the retailer could partner, etc.). It will be appreciated that while examples relating to various publishers, websites, and content are provided herein, aspects of the present disclosure may be applied to any of a wide variety of publishers, websites, and content.

Accordingly, the present disclosure provides systems and methods for suggested content generation. Suggested content may be generated for display by a publisher, wherein the suggested content may relate to a determined browsing session of a user. As an example, when a user accesses a website of a publisher, the website may comprise a widget used to display suggested content to the user. The suggested content may comprise one or more predicted search queries, other relevant publishers, or webpages or websites, among other content. As such, the user may interact with the suggested content while continuing a browsing session, rather than starting a new search using a search engine or navigating to a different publisher. This may enable additional information to be gathered, which may be used to engage in analytics that may not otherwise be possible if the user had not interacted with the suggested content. Further, the suggested content may omit content provided by the publisher, so as to avoid providing redundant content or reducing user interest in the content provided by the publisher. In some examples, revenue may be generated as a result of the user interacting with the suggested content, at least a part of which may be shared with the publisher.

A widget for displaying suggested content may be used by a publisher. In an example, the widget may be provided by recommendation provider (e.g., a search provider, a retailer, a content producer, a data analytics provider, etc.). In some examples, the widget may comprise code that, when executed, generates a request for suggested content. For example, the widget may comprise code that executes in a browser application of a client device, code that executes on a server device of publisher, or any combination thereof. Suggested content may then be received, which may be displayed in addition to content provided by the publisher. In other examples, the widget may be part of a website search service (e.g., as may be provided by a search provider, as part of a web hosting service or webserver, etc.), such that the publisher may incorporate the website search service as part of a website. The suggested content may then be displayed as part of the search results provided by the website search service. In another example, the widget may be part of a chatbot service, wherein the chatbot may converse with a user regarding content from a publisher. The chatbot may provide suggested content during a conversation with the user. As an example, suggested content may be provided as a result of receiving user input relating to content that isn't available from or isn't discussed in detail by the publisher.

Suggested content may be generated based on any of a variety of information sources, including, but not limited to, publisher information from a publisher data store (e.g., an index of publisher content, a category or domain associated with the publisher, information specified by a publisher, etc.), query session information (e.g., query records or logs, search index information, etc.), or user information (e.g., browsing history, demographic information, purchase history, etc.). According to aspects disclosed herein, such information may be labeled and/or categorized in order to identify relevant training information. In some examples, the model may be trained based on success criteria comprising whether the suggested content was informative or relevant to the browsing session of the user, as may be determined based on user interaction with the suggested content. In an example, a generative or sequence-to-sequence model may be used. An n-gram model with sequences of browsing session topics may be created based on one or more of the above-mentioned information sources, wherein sequences of browsing session topics may be demarcated with start and end boundaries. At runtime, suggested content relating to a predicted next browsing session topic may be determined for a user using Viterbi or Expectation Maximization (EM) decoding techniques. For example, a next browsing topic or query (qₜ₊₁) for a user (u) may be predicted given the history of the user's browsing topics or queries (qₜ, qₜ₋₁, etc.) and the domain (dₜ) related to the user's browsing session:

p(qₜ₊₁|qₜ, qₜ₋₁, . . . , q₀, u, dₜ)

In another example, suggested content may be generated based on information in a search index (e.g., from one or more websites containing relevant information, based on typical query patterns, etc.). As an example, the search index information may comprise websites that have information relating to similar content (e.g., “users also purchased” or “users also viewed,” etc.). In some examples, a publisher may provide information that may be used when generating suggested content, such as relevant key words or domains, similar content or publishers, among other examples. Further, the suggested content may omit content provided by the publisher (e.g., as may be determined based on information from the publisher data store), so as to avoid providing redundant content or reducing user interest in the content provided by the publisher. It will be appreciated that while example techniques and information are disclosed herein, alternate techniques or information may be used without departing from the present disclosure.

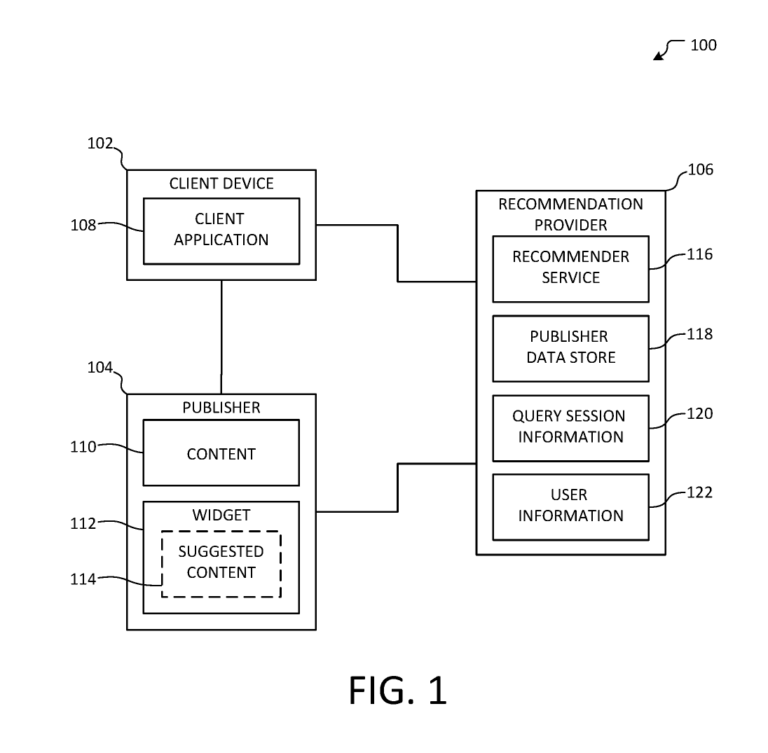

FIG. 1 illustrates an overview of an example system 100 for suggested content generation. System 100 is comprised of client device 102, publisher 104, and recommendation provider 106. In an example, client device may be a mobile computing device, a tablet computing device, a laptop or desktop computing device, or any other type of computing device. Publisher 104 may be a website, a retailer, a travel agency, a news source, or any other publisher of content. Recommendation provider 106 may be a search provider, a retailer, a content producer, or a data analytics provider, among others.

As illustrated, client device 102 comprises client application 108. Client application 108 may be an interne browser application (e.g., MICROSOFT EDGE, MICROSOFT INTERNET EXPLORER, GOOGLE CHROME, etc.), an electronic communication application (e.g., an instant messaging or electronic mail application, etc.), or any other application that may be used to access content 110 from publisher 104. Publisher 104 comprises content 110 and widget 112, wherein widget 112 facilitates the display of suggested content 114. Content 110 may be any of a variety of content made available by publisher 104 (e.g., via one or more computing devices) including, but not limited to, a website comprising one or more webpages, or a chatbot used to provide information to users via an instant messaging platform. When providing content 110 to a user of client device 102, widget 112 may also be provided. As discussed herein, widget 112 may comprise code that, when executed, generates a request for suggested content. For example, the widget may comprise code that is executed by client application 108 of client device 102, code that executes on a server device of publisher 104, or any combination thereof. Suggested content 114 is illustrated using a dashed box to indicate that widget 112 may not comprise suggested content 114, but rather may facilitate the retrieval of suggested content 114 from recommendation provider 106. In some examples, widget 112 may comprise suggested content 114 when provided to client application 108, such as, for example, when widget 112 is executed at least in part by a computing device of publisher 104.

Recommendation provider 106 comprises recommender service 116, publisher data store 118, query session information 120, and user information 122. Publisher data store 118 may comprise information relating to publisher 104, such as one or more domains relating to publisher 104 and/or content 110, an index of content 110, one or more keywords (e.g., as may have been provided by publisher 104 or determined based on content 110), etc. Query session information 120 may comprise query records, query logs, and/or search index information. In some examples, query session information 120 may comprise browsing session information of one or more users. User information 122 may comprise browsing history, demographic information, or purchase history, among other user information. While elements 118-122 are illustrated as part of recommendation provider 106, it will be appreciated that information may be stored or accessed from additional or alternative sources, such as a data store, client device 102, and/or publisher 104.

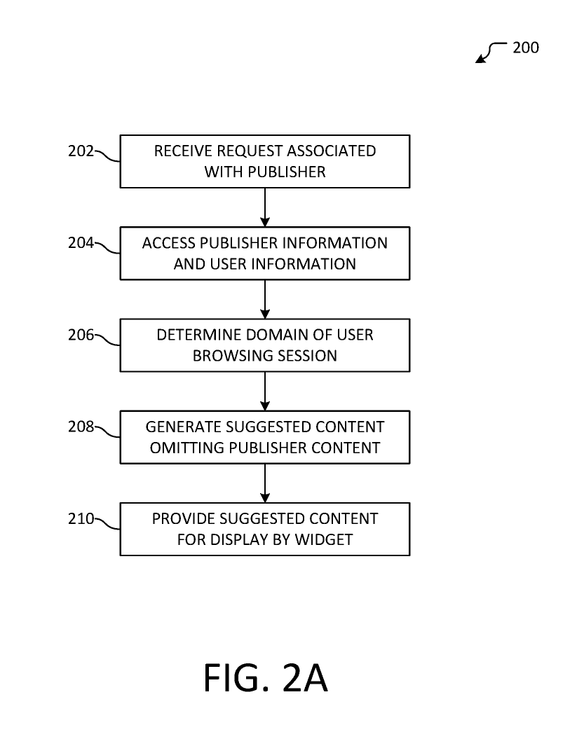

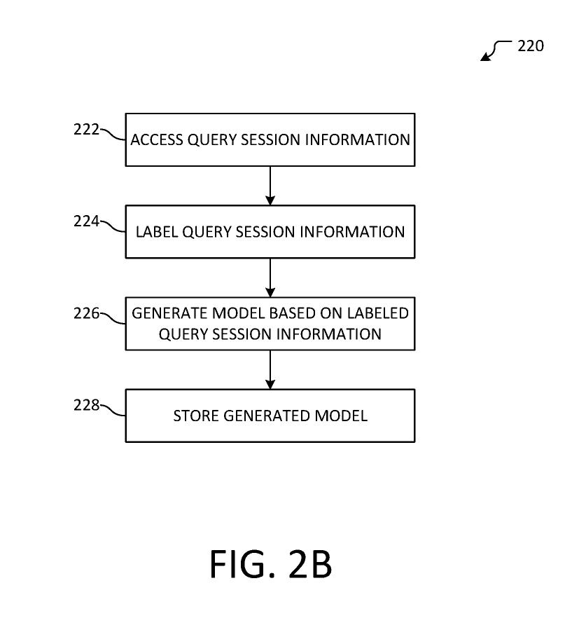

Recommender service 116 may generate suggested content 114 for display by widget 112 on client device 102. In an example, recommender service 116 may generate a model based on information from publisher data store 118, query session information 120, and/or user information 122, wherein the model may be used to determine a predicted next browsing session topic for a user of client device 102. In some examples, an n-gram model comprising sequences of browsing session topics may be created based on information from query session information 120, as will be discussed in greater detail below with respect to FIG. 2B. In another example, suggested content may be generated based on search index information from query session information 120, such as websites that have information relating to similar content (e.g., “users also purchased” or “users also viewed” webpages, etc.). In one example, recommender service 116 may access publisher-provided information from publisher data store 118 or may access information generated as a result of user interactions with suggested content 114 (e.g., click-through rates, efficacy information, etc.).

Recommender service 116 may receive a request for suggested content 114 (e.g., as may be generated by widget 112 when client device 102 accesses content 110). In an example, the request may be received from client device 102 or publisher 104. The request may comprise information relating to a user of client device 102, client device 102, client application 108, publisher 104, and/or content 110. Recommender service 116 may generate suggested content 114 to provide in response to the request, which may comprise applying a model as discussed herein. The model may be applied based on a browsing history for a user (e.g., as may be stored by user information 122 or provided by client device 102) or a domain for a browsing session of a user, among other variables. In some examples, the browsing history may be weighted or filtered (e.g., based on a relevancy threshold, based on recency, etc.). In another example, recommender service 116 may generate suggested content 114 based on keywords or other information received from publisher 104, as may be stored in publisher data store 118 and/or may have been received as part of the request. Recommender service 116 may generate and/or filter the suggested content 114 in view of publisher information (e.g., as may be stored in publisher data store 118 or received as part of the request, etc.), so as to avoid providing redundant content or reducing user interest in content 110 provided by publisher 104.

FIG. 2A illustrates an overview of an example method 200 for suggested content generation. In an example, method 200 may be performed by one or more computing devices. In some examples, method 200 may be performed by recommender service 116 in FIG. 1. Method 200 begins at operation 202, where a request associated with a publisher is received. The request may be received from a client device (e.g., client device 102 in FIG. 1) or a server device of a publisher (e.g., publisher 104 in FIG. 1). The request may have been generated by a widget as described herein, such as widget 112 in FIG. 1. As an example, the request may have been generated as a result of executing code in a browser of a client device that loaded a website of a publisher. In some examples, the request may comprise a source identifier (e.g., a referrer Uniform Resource Locator (URL), a Uniform Unique Identifier (UUID), etc.), wherein the source identifier may relate to the content with which the widget is associated.

Moving to operation 204, publisher information and user information may be identified. The information may be identified by accessing a data store, identified by evaluating the received request, or a combination thereof. As discussed herein, the publisher information may comprise an index of publisher content, a category or domain associated with the publisher, or information specified by a publisher (e.g., one or more keywords, categories or domains, etc.). User information may comprise browsing history, demographic information, purchase history, or other information relating to a user as may be provided by a client device.

At operation 206, a domain may be determined for the browsing session of the user. In an example, the domain may be determined based on a source identifier or other information received as part of the request (e.g., publisher information and/or other user information, etc.). In another example, the content associated with the request may be analyzed to determine the domain. In some examples, the determination may be based on information received from or associated with the publisher, as may be stored in a publisher data store (e.g., publisher data store 118 in FIG. 1). While examples have been discussed herein, it will be appreciated that other techniques may be used to determine a domain associated with a browsing session of the user.

Moving to operation 208, suggested content may be generated, wherein the suggested content may omit content associated with the publisher. According to aspects disclosed herein, the suggested content may be generated by applying a model (e.g., an n-gram model, a sequence-to-sequence model, or other generative model, etc.), based on one or more keywords provided by the publisher, and/or using search index information relating to recommended content (e.g., “users also purchased” or “users also viewed” webpages, etc.). The suggested content may omit content associated with the publisher, such that content provided by the publisher is not rendered redundant or user interest in the publisher's content is not reduced. Content may be omitted based on similarity of the suggested content to content provided by the publisher (e.g., as may be determined from an index of publisher content), the degree to which the publisher provides similar content (e.g., whether the suggested content relates to content that is briefly mentioned by the publisher versus content that is the main focus of the publisher), or based on one or more blacklisted keywords or domains received from the publisher, among other criteria.

At operation 210, the suggested content may be provided for display by the widget. Providing the suggested content may comprise providing at least a part of the suggested content to the requestor, storing the suggested content using a data store and providing the location of the stored suggested content, or making the suggested content available via a server or other remote computing device and providing a URL to the suggested content, among other techniques. In some examples, the suggested content may be provided to a client device (e.g., for display in a browser or other client application executing on the client device) or to a server or other computing device, wherein the suggested content may be incorporated alongside content from the publisher (e.g., as part of search results, as part of a chatbot response, etc.) for display to a user. Flow terminates at operation 210.

FIG. 2B illustrates an overview of an example method 220 for generating a model with which to perform suggested content generation. In an example, method 220 may be performed by one or more computing devices. In some examples, method 220 may be performed by recommender service 116 in FIG. 1. Method 220 begins at operation 222, where query session information may be identified. As described herein, query session information may comprise query records, query logs, and/or search index information. As an example, query session information may be generated by a search provider based on a series of received user queries.

Moving to operation 224, the query session information may be labeled or categorized. As an example, query reformulations may be identified and labeled as such. A query reformulation may not represent a new browsing session topic during the browsing session of a user, but may instead be a continuation of the same browsing session topic. A query reformulation may be identified based on the similarity of query terms, the similarity of the result set, and/or the similarity of the results viewed by the user, among other techniques. In another example, social queries may be identified and labeled as such. A social query may be a query that interrupts a browsing session, such as a query for an email service or a social network. A social query may be identified based on a set of domains identified as social domains or based on an association of query keywords with a set of social keywords, etc. In some examples, a categorizer may be used to label the query session information based on one or more categories, wherein the categorizer may label a query as belonging to a certain category (e.g., navigational, commercial, travel, retail, social, news, etc.). The categorizer may evaluate the result set associated with a query and/or one or more keywords of the query, among other criteria, in order to identify a category associated with a query. In another example, one or more subcategories may also be identified for a query.

At operation 226, a model may be generated based on the query session information that was labeled at operation 224. In some examples, queries labeled as reformulation queries and social queries may be omitted, such that categorized queries and/or other relevant queries remain for generating the training data to train a model. In an example, a query may be analyzed with respect to other queries that were categorized similarly within a browsing session, such that a similarity measure between a pair of queries (q₁, q₂) may be used to determine when a user pivots to a new browsing session topic given q₁. In other examples, a count measure may be generated based on the number of occurrences of a query pair across multiple browsing sessions. A distance measure may be generated based on a time interval and/or number of queries between two queries in a query pair. Thus, training samples may be generated in order to predict the next most relevant query, such that the next most relevant query may be different from a user's current query. In an example, a distance measure and/or a count measure may be used as an alternative or in addition to the similarity measure. Each pair of queries may then be weighted using the similarity measure, the count measure, and/or the distance measure, wherein the weighting may be proportional to the similarity and the count measures, but inversely proportional to the distance measure. In some examples, one or more query pairs may be used to generate suggested content, wherein the first query of the pair is associated with the user's current browsing session topic, while the second query of the pair is the highest weighted query identified by the model (e.g., based on the similarity measure, the count measure, and/or the distance measure). In other examples, one or more query pairs may comprise training data that may be used to train a model as described herein, such as a sequence-to-sequence model or an n-gram model, among other models.

Moving to operation 228, the generated model may be stored. In some examples, the model may be stored using a local storage device, a remote data store, or a combination thereof. In other examples, multiple models may be generated, wherein a model is associated with one or more domains, publishers, target demographics, and/or geographic regions, etc. Accordingly, when generating suggested content (e.g., as was discussed above with respect to FIG. 2A), the model may be accessed and used to identify a next probable browsing session topic based on a current browsing session topic. Flow terminates at operation 228.

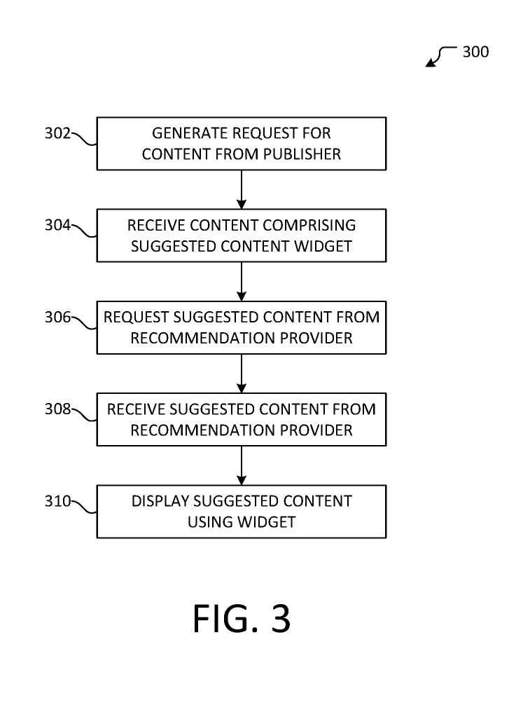

FIG. 3 illustrates an overview of an example method 300 for requesting and displaying suggested content. Method 300 may be performed by a client device, such as client device 102 in FIG. 1. Method 300 begins at operation 302, where a request for content from a publisher may be generated. As an example, the request may be generated by a browser application executing on the client device, wherein the request is for a webpage comprising content from the publisher.

At operation 304, content is received in response to the request, where the content comprises a suggested content widget. As discussed herein, the widget may be associated with a recommendation provider, such as widget 112 associated with recommendation provider 106 in FIG. 1. The widget may comprise executable code, such as JavaScript or plugin code, which may execute in the browser of the client device.

At operation 306, suggested content may be requested from a recommendation provider. The request may be generated as a result of executing code comprising the widget received at operation 304. In some examples, the request may comprise a source identifier, such as a referrer URL or a UUID, among others. The request may comprise information associated with the content, the user of the client device, and/or the publisher. For example, the publisher may provide a widget that comprises one or more keywords, which may be sent by the client device when executing the code provided by the widget.

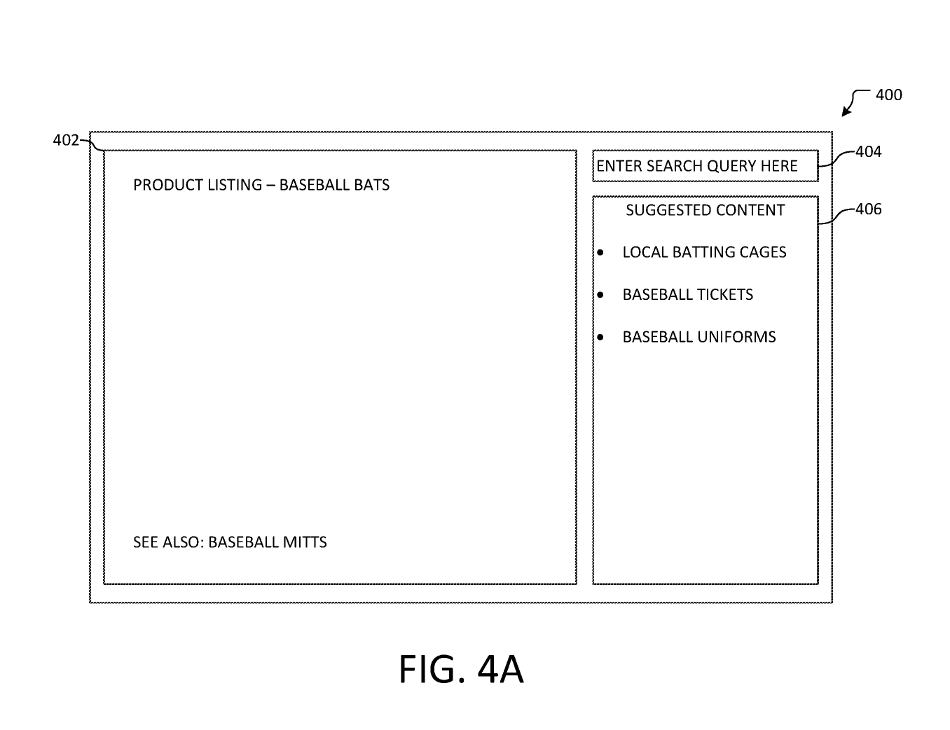

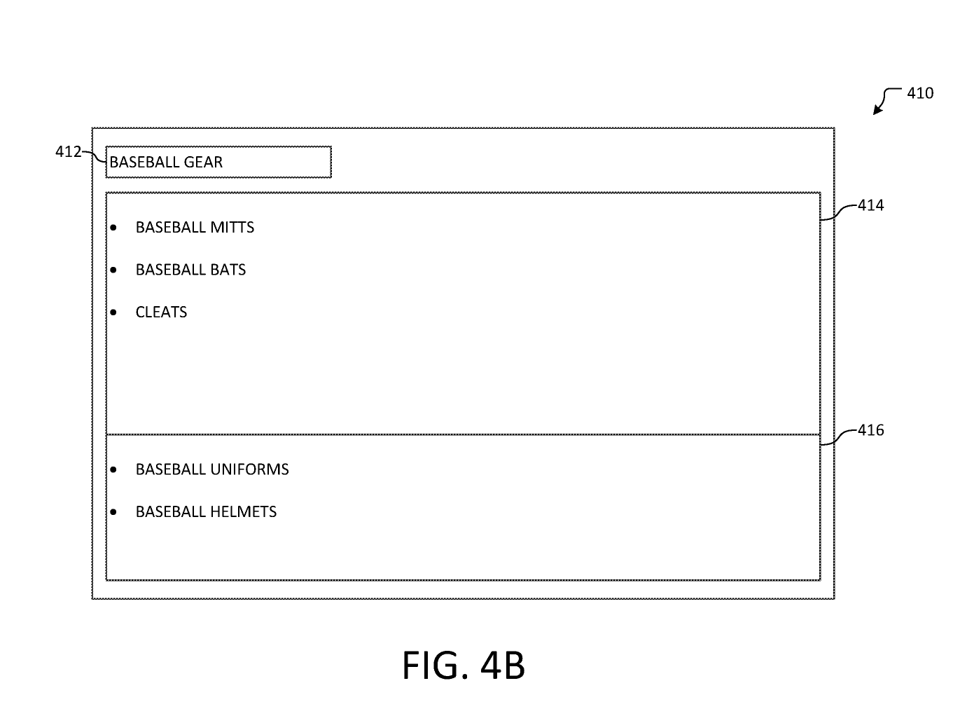

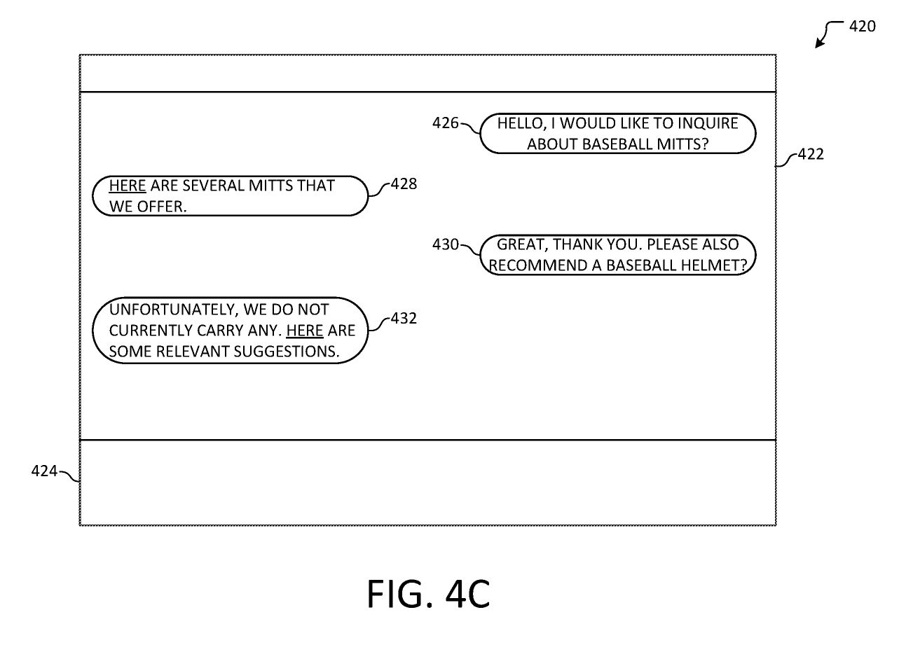

Moving to operation 308, suggested content may be received from the recommendation provider. As an example, the suggested content may be received as HTML code, as a JSON object, or as other content that may be displayed by the widget. In another example, a reference to the suggested content may be received, such that the widget may access or retrieve the suggested content based on the received reference. At operation 310, the suggested content may be displayed using the widget. As an example, the widget may present the suggested content alongside the content received from the publisher in operation 302, as will be discussed below with respect to FIG. 4A. Flow terminates at operation 310.

FIG. 4A illustrates an overview of example user interface 400 for displaying suggested content. As illustrated, user interface 400 comprises content 402, search bar 404, and suggested content widget 406. User interface 400 may be the user interface of a client application, such as a browser application executing on any type of computing device. As discussed above, content 402 may be received from a publisher, and may be related to a browsing session topic of a user. As illustrated, content 402 comprises a product listing for baseball bats, wherein the publisher also provides content (e.g., one or more product listings) relating to baseball mitts, as evidenced by the “SEE ALSO: BASEBALL MITTS” at the bottom of content 402.

Search bar 404 may provide website search functionality, wherein content provided by the publisher may be searched by entering one or more keywords in to search bar 404, which will be discussed in greater detail below with respect to FIG. 4B. Suggested content widget 406 may be provided by the publisher in addition to content 402, whereby suggested content may be requested and displayed in addition to content 402. As illustrated, suggested content widget 406 comprises suggested content relating to local batting cages, baseball tickets, and baseball uniforms. The suggested content displayed by suggested content widget 406 may have been generated according to aspects disclosed herein, such that relevant content relating to one or more predicted next browsing session topics for the user are presented. However, suggested content widget 406 may omit or filter out content that is provided by the publisher, such as product listings for baseball mitts.

FIG. 4B illustrates an overview of example user interface 410 for displaying suggested content. As illustrated, user interface 410 comprises search bar 412, content 414, and suggested content widget 416. User interface 410 may comprise search results received in response to performing a website search of a publisher. As illustrated, a search for “BASEBALL GEAR” was performed using search bar 412. Results were returned, as illustrated in content 414, wherein the results comprise “BASEBALL MITTS,” “BASEBALL BATS,” and “CLEATS.”

Suggested content widget 416 may be provided in addition to content 414, wherein suggested content may be displayed in addition to content 414. As illustrated, suggested content widget 416 comprises suggested content relating to baseball uniforms and baseball helmets. The suggested content displayed by suggested content widget 416 may have been generated according to aspects disclosed herein, such that relevant content relating to the query for “BASEBALL GEAR” in search bar 402 is presented. However, suggested content widget 416 may omit content that is provided by the publisher, such as the product listings displayed in content 414. As a result, a user searching for content not provided by the publisher may still find relevant results via suggested content widget 416, thereby enabling the publisher to gather data regarding which additional products should be made available, among other information. In an example, revenue may be generated as a result of a user interacting with the suggested content, which, in some examples, may be shared with the publisher.

FIG. 4C illustrates an overview of example user interface 420 for displaying suggested content. As illustrated, user interface 420 comprises a conversation interface for communicating with a chatbot. User interface 420 comprises message pane 422 and text input pane 424. Messages sent and received during a communication session (e.g., messages 426-432) may be displayed in message pane 422. Messages on the right side of message pane 422 (e.g., messages 426 and 430) may be messages sent by a user, while messages on the left side of message pane 422 (e.g., messages 428 and 432) may be messages received from the chatbot.

As illustrated, the user requests information about available baseball mitts in message 426. Given that the publisher has several baseball mitts available, the chatbot may provide content from the publisher in the form of a link, as indicated by the underlined portion in message 428. The user subsequently inquires about baseball helmets in message 430, which, unfortunately, are not sold by the publisher. As a result, the chatbot may instead provide suggested content (e.g., generated by a widget, as described above) in message 432, wherein a link to relevant suggestions may be provided. It will be appreciated that while the content and suggested content are illustrated as links in messages 428 and 432, the chatbot may provide rich content, interactive content, web content, or any other type of response during the conversation session.

While example user interface elements, content, and techniques have been discussed above with respect to FIGS. 4A-4C, it will be appreciated that alternative user interface elements, content, and/or techniques may be used to generate and/or provide suggested content without departing from the spirit of this disclosure.

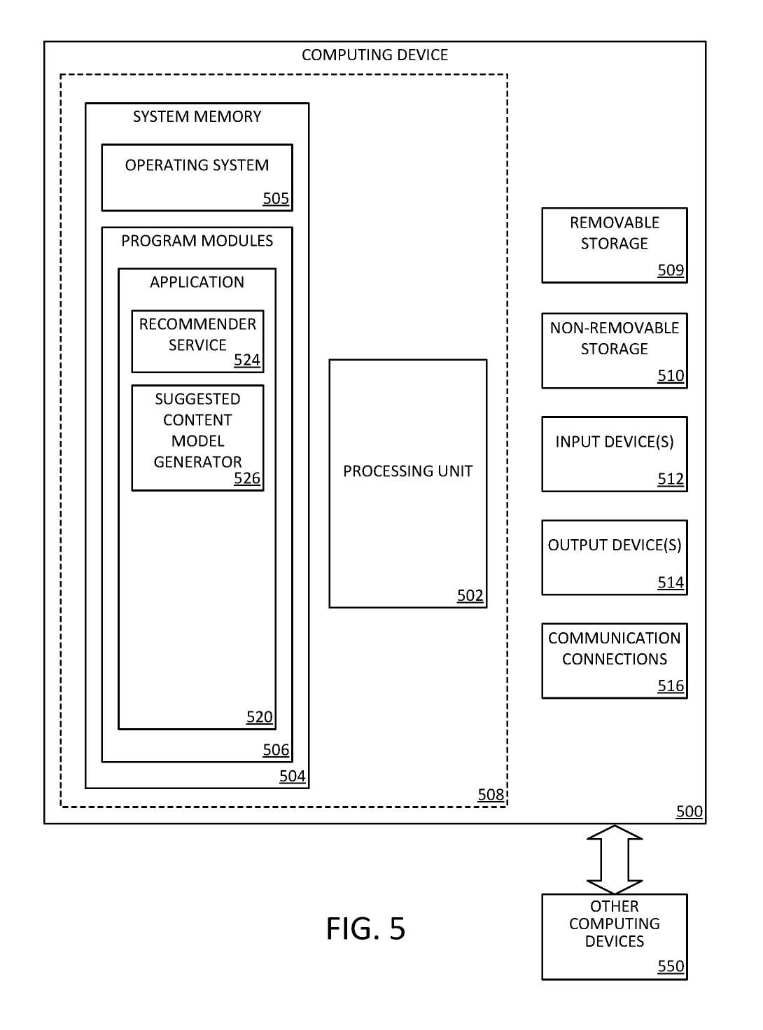

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for performing the various aspects disclosed herein such as recommender service 524 and suggested content model generator 526. The operating system 505, for example, may be suitable for controlling the operation of the computing device 500. Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

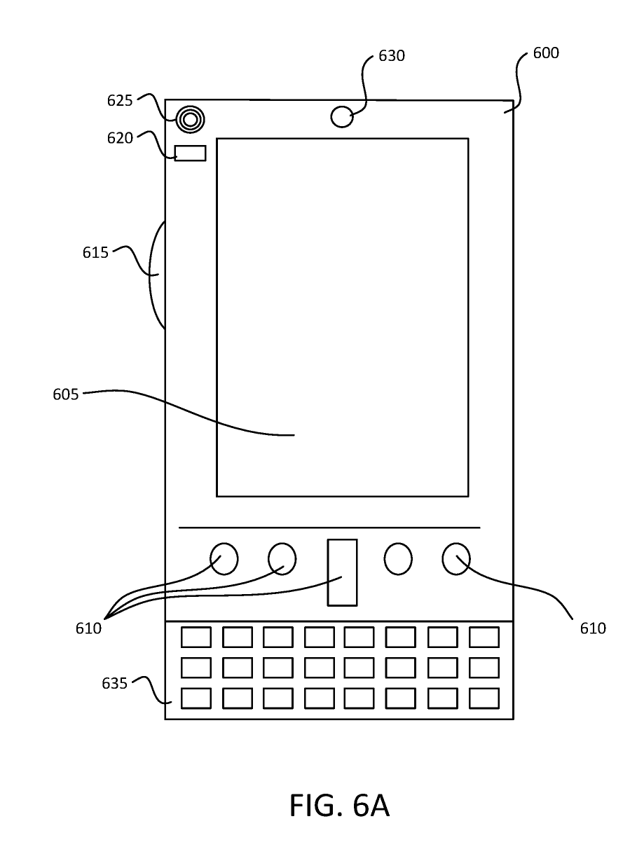

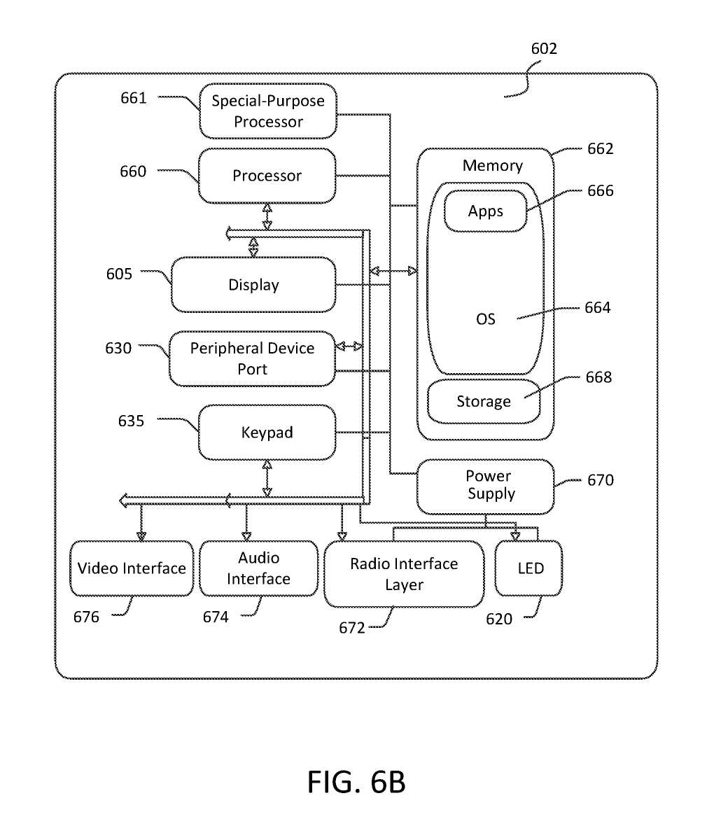

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

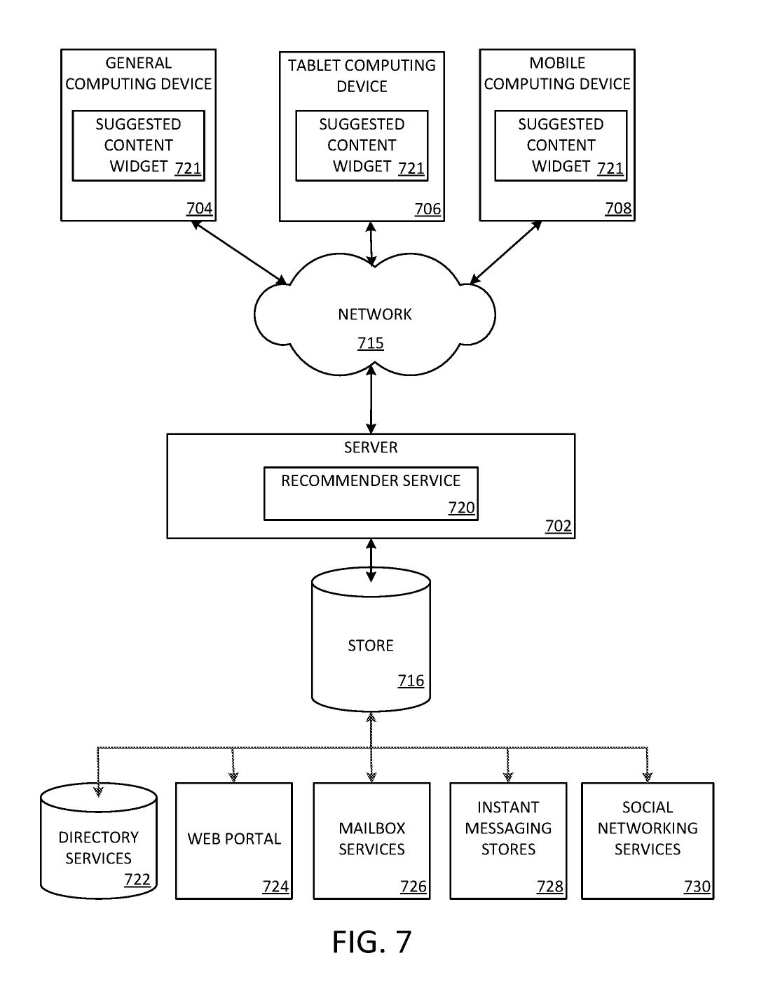

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730. Suggested content widget 721 may be employed by a client that communicates with server device 702, and/or recommender service 720 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

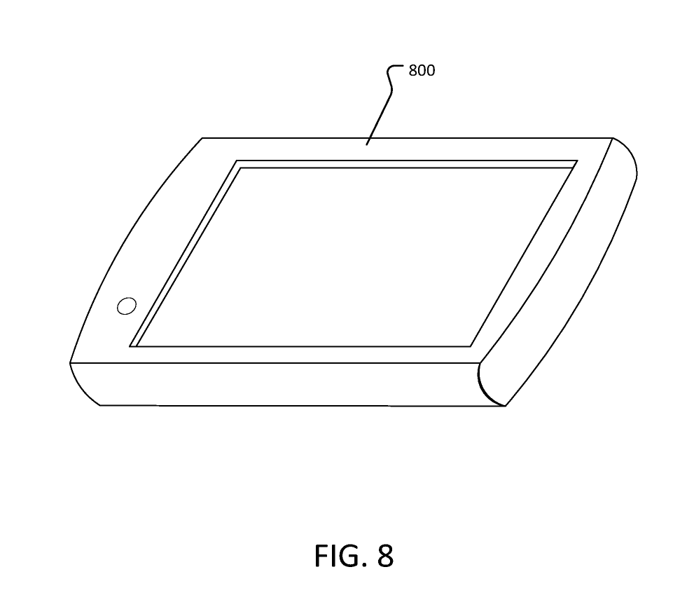

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: receiving, from a client device, a request associated with a webpage, wherein the webpage is associated with a website of a publisher; identifying publisher information associated with the publisher; determining a domain associated with the request; generating, based on the domain, one or more predicted search queries, wherein the one or more predicted search queries comprise search queries unrelated to the publisher information; and providing the one or more predicted queries for display by the webpage. In an example, the publisher information associated with the publisher comprises an index of webpages of the website. In another example, generating the one or more predicted search queries comprises evaluating a model based on at least one of the domain and user information associated with the client device. In a further example, the webpage comprises a product listing, and wherein at least one of the one or more predicted search queries relates to another product listing. In yet another example, the publisher information associated with the publisher comprises one or more product listings of the website. In a further still example, generating the one or more predicted search queries comprises evaluating search index information comprising content relating to the product listing, and wherein the content provides at least one related product listing. In an example, the request is received from a widget on the user device.

In another aspect, the technology relates to a method for suggested content generation. The method comprises: identifying query session information, wherein the query session information comprises a plurality of series of queries; determining, for each of the series of queries, a label associated with the series of queries; filtering, based on the determined labels, social queries and query reformulations from the query session information to generate filtered query session information; generating, based on the filtered query session information, a suggested content generation model, wherein the suggested content generation model comprises one or more query pairs determined to be similar, and wherein each query pair comprises a first query and a second query, the second query likely to be the next query after the first query during a browsing session of a user; and storing the suggested content generation model. In an example, determining the label associated with each series of queries comprises using a categorizer to identify a category associated with each series of queries. In another example, the suggested content generation model comprises query pairs each relating to the same identified category. In a further example, filtering comprises identifying query reformulations based on one of keyword similarity and result set similarity. In yet another example, the query session information is associated with a domain, and wherein storing the suggested content generation model comprises associating the suggested content generation model with the domain. In a further still example, the method further comprises ranking the one or more query pairs of the suggested content generation model based on at least one of a similarity measure, a distance measure, and a count measure for each query pair.

In a further aspect, the technology relates to another method for suggested content generation. The method comprises: receiving, from a client device, a request associated with a webpage, wherein the webpage is associated with a website of a publisher; identifying publisher information associated with the publisher; determining a domain associated with the request; generating, based on the domain, one or more predicted search queries, wherein the one or more predicted search queries comprise search queries unrelated to the publisher information; and providing the one or more predicted queries for display by the webpage. In an example, the publisher information associated with the publisher comprises an index of webpages of the website. In another example, generating the one or more predicted search queries comprises evaluating a model based on at least one of the domain and user information associated with the client device. In a further example, the webpage comprises a product listing, and wherein at least one of the one or more predicted search queries relates to another product listing. In yet another example, the publisher information associated with the publisher comprises one or more product listings of the website. In a further still example, generating the one or more predicted search queries comprises evaluating search index information comprising content relating to the product listing, and wherein the content lists one or more related products. In another example, the request is received from a widget on the user device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving, from a client device, a request associated with a webpage, wherein the webpage is associated with a website of a publisher;
identifying publisher information associated with the publisher;
determining a domain associated with the request;
generating, based on the domain, one or more predicted search queries, wherein the one or more predicted search queries comprise search queries unrelated to the publisher information; and
providing the one or more predicted queries for display by the webpage.

2. The system of claim 1, wherein the publisher information associated with the publisher comprises an index of webpages of the website.

3. The system of claim 1, wherein generating the one or more predicted search queries comprises evaluating a model based on at least one of the domain and user information associated with the client device.

4. The system of claim 1, wherein the webpage comprises a product listing, and wherein at least one of the one or more predicted search queries relates to another product listing.

5. The system of claim 4, wherein the publisher information associated with the publisher comprises one or more product listings of the website.

6. The system of claim 4, wherein generating the one or more predicted search queries comprises evaluating search index information comprising content relating to the product listing, and wherein the content provides at least one related product listing.

7. The system of claim 1, wherein the request is received from a widget on the user device.

8. A method for generating a model for suggested content generation, comprising:
identifying query session information, wherein the query session information comprises a plurality of series of queries;
determining, for each of the series of queries, a label associated with the series of queries;
filtering, based on the determined labels, social queries and query reformulations from the query session information to generate filtered query session information;
generating, based on the filtered query session information, a suggested content generation model, wherein the suggested content generation model comprises one or more query pairs determined to be similar, and wherein each query pair comprises a first query and a second query, the second query likely to be the next query after the first query during a browsing session of a user; and
storing the suggested content generation model.

9. The method of claim 8, wherein determining the label associated with each series of queries comprises using a categorizer to identify a category associated with each series of queries.

10. The method of claim 9, wherein the suggested content generation model comprises query pairs each relating to the same identified category.

11. The method of claim 8, wherein filtering comprises identifying query reformulations based on one of keyword similarity and result set similarity.

12. The method of claim 8, wherein the query session information is associated with a domain, and wherein storing the suggested content generation model comprises associating the suggested content generation model with the domain.

13. The method of claim 8, further comprising ranking the one or more query pairs of the suggested content generation model based on at least one of a similarity measure, a distance measure, and a count measure for each query pair.

14. A method for suggested content generation, comprising:
receiving, from a client device, a request associated with a webpage, wherein the webpage is associated with a website of a publisher;
identifying publisher information associated with the publisher;
determining a domain associated with the request;
generating, based on the domain, one or more predicted search queries, wherein the one or more predicted search queries comprise search queries unrelated to the publisher information; and
providing the one or more predicted queries for display by the webpage.

15. The method of claim 14, wherein the publisher information associated with the publisher comprises an index of webpages of the website.

16. The method of claim 14, wherein generating the one or more predicted search queries comprises evaluating a model based on at least one of the domain and user information associated with the client device.

17. The method of claim 14, wherein the webpage comprises a product listing, and wherein at least one of the one or more predicted search queries relates to another product listing.

18. The method of claim 17, wherein the publisher information associated with the publisher comprises one or more product listings of the website.

19. The method of claim 17, wherein generating the one or more predicted search queries comprises evaluating search index information comprising content relating to the product listing, and wherein the content lists one or more related products.

20. The method of claim 14, wherein the request is received from a widget on the user device.
